(19) United States
(12) Patent Application Publication
(10) Pub. No.: US 2013/0240279 A1
(43) Pub. Date: Sep. 19, 2013

(54) HYBRID TANDEM DRIVE AXLE OF A TRUCK VEHICLE

(71) Applicants: Colin Jay Casey, Fort Wayne, IN (US); Robert A. Weber, Grabhill, IN (US)

(72) Inventors: Colin Jay Casey, Fort Wayne, IN (US); Robert A. Weber, Grabhill, IN (US)

(73) Assignee: INTERNATIONAL TRUCK INTELLECTUAL PROPERTY COMPANY LLC, LISLE, IL (US)

(21) Appl. No.: 13/988,998

(22) PCT Filed: Dec. 10, 2010
(86) PCT No.: PCT/US10/59865

§ 371 Date: May 22, 2013

(51) Int. Cl. B60K 6/48; B60K 6/12

(52) U.S. Cl. CPC B60K 6/48; B60K 6/12; Y10S 903/93; Y10S 903/951
USPC 180/69.6; 903/951; 903/930

(57) ABSTRACT

A tandem rear axle (28) suspended from a chassis frame (12) rearward of front steerable wheels (22, 24) has a first drive axle (30) with a driven wheel (32) on the right side and a driven wheel (34) on the left side and a second drive axle (36) rearward of the first drive axle and having a driven wheel (38) on the right side and a driven wheel (40) on the left side. A drivetrain couples a combustion engine (26) to the first drive axle for driving its driven wheels. A prime mover (52, 68, 70, 74) other than the combustion engine drives the driven wheels of the second drive axle.

### TECHNICAL FIELD

This disclosure relates to truck vehicles, particularly to truck vehicles having tandem drive axles.

### BACKGROUND

Certain truck vehicles have a tandem drive axle comprising a first drive axle that is forward of a second drive axle. One of the purposes of having a tandem drive axle is for enabling the vehicle to carry a larger load because the load weight is distributed to the underlying road service through a greater number of wheels.

In one type of tandem drive axle, the first drive axle is coupled by a drivetrain to a combustion engine for propelling driven wheels of the first drive axle. The second drive axle is mechanically coupled to the drivetrain and/or the first drive axle so that driven wheels of the second drive axle are also driven by the combustion engine. When the axles are operated in a 1:1 ratio, the wheels will rotate in unison due to the mechanical coupling when steered wheels at the front of the vehicle are steering the vehicle in a straight line. If there is a difference in diameter between the tire on the first drive axle on one side of the vehicle and the tandem tire on the same side of the vehicle, there can be mismatch in circumference of the tires in the first and second axles, causing friction between the gears between the axles and also causing friction and slip between tandem tires and the underlying road surface. Tire friction can accelerate tire wear and the friction in the gears can impair fuel economy. When the vehicle is being turned by the steered wheels, differential gear mechanisms of the respective drive axles will allow wheels on opposite sides of each drive axle to rotate at slightly different speeds.

Another type of tandem drive axle comprises a driven axle and a non-driven axle. When the non-driven axle is rearward of the driven axle, the non-driven axle is sometimes referred to as a tag axle. When the non-driven axle is in front of the driven axle, the non-driven axle is sometimes referred to as a pusher axle.

### SUMMARY OF THE DISCLOSURE

The present disclosure relates to a truck vehicle comprising a chassis having a length extending front to rear, a right side, and a left side.

Front steerable wheels are suspended from the chassis on the right and left sides for steering the truck vehicle.

A combustion engine is supported on the chassis.

A tandem rear axle is suspended from the chassis rearward of the front steerable wheels and comprises a first drive axle comprising at least one driven wheel on the right side and at least one driven wheel on the left side and a second drive axle rearward of the first drive axle and comprising at least one driven wheel on the right side and at least one driven wheel on the left side.

A drivetrain couples the combustion engine to the first drive axle for driving the at least one driven wheel on the right side and the at least one driven wheel on the left side of the first drive axle.

A prime mover other than the combustion engine drives the at least one driven wheel on the right side and the at least one driven wheel on the left side of the second drive axle.

Examples of prime movers are electric motors and hydraulic motors.

The present disclosure also relates to a method of propelling a truck vehicle that comprises a chassis having a length extending front to rear, a right side, and a left side, front steerable wheels suspended from the chassis on the right and left sides for steering the truck vehicle, a combustion engine supported on the chassis, a tandem rear axle suspended from the chassis rearward of the front steerable wheels and comprising a first drive axle comprising at least one driven wheel on the right side and at least one driven wheel on the left side and a second drive axle rearward of the first drive axle and comprising at least one driven wheel on the right side and at least one driven wheel on the left side, a drivetrain coupling the combustion engine to the first drive axle for driving the at least one driven wheel on the right side and the at least one driven wheel on the left side of the first drive axle.

The method comprises operating a prime mover other than the combustion engine for driving the at least one driven wheel on the right side and the at least one driven wheel on the left side of the second drive axle.

Examples of prime movers are electric motors and hydraulic motors.

The foregoing summary, accompanied by further detail of the disclosure, will be presented in the Detailed Description below with reference to the following drawings that are part of this disclosure.

### BRIEF DESCRIPTION OF THE DRAWINGS

FIG. 1 is a schematic diagram depicting a top plan view of a truck vehicle chassis.

FIG. 2 is an enlarged view of a portion of FIG. 1 showing a first embodiment.

FIG. 3 is a view similar to FIG. 2 showing a second embodiment.

FIG. 4 is a view similar to FIG. 2 showing a third embodiment.

FIG. 5 is a view similar to FIG. 2 showing a fourth embodiment.

FIG. 6 is a view similar to FIG. 2 showing a fifth embodiment.

FIG. 7 is a view similar to FIG. 2 showing a sixth embodiment.

FIG. 8 is a view similar to FIG. 1 showing a truck vehicle chassis have a tandem rear axle with dual wheels.

### DETAILED DESCRIPTION

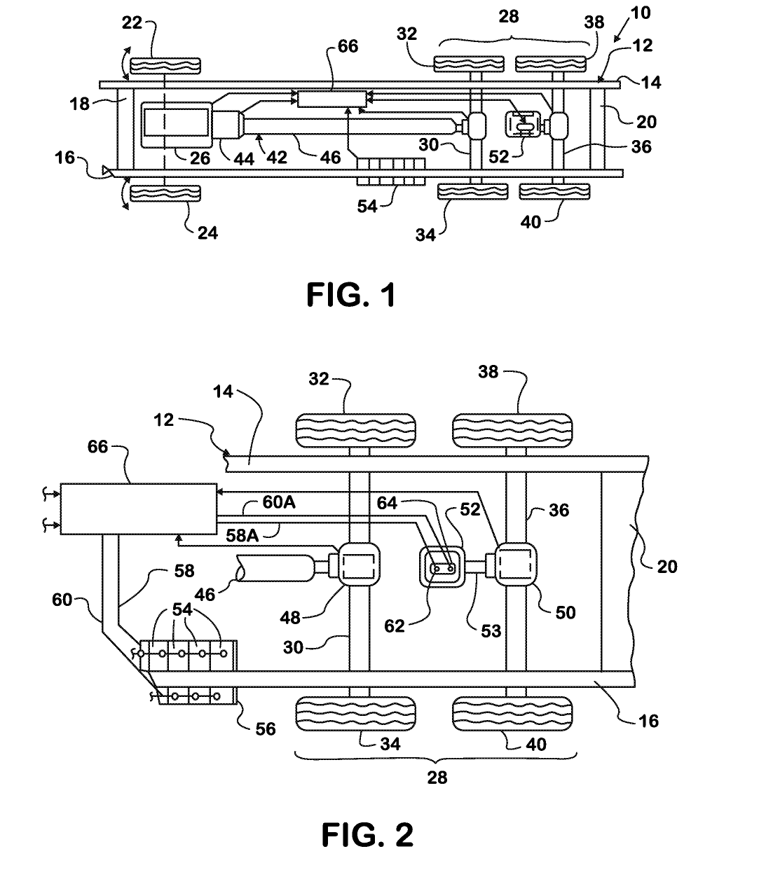

FIGS. 1 and 2 show a truck vehicle chassis 10 having a length extending front to rear, a right side, and a left side. Chassis 10 comprises a frame 12 having right side rail 14 extending front to rear, a left side rail 16 extending front to rear, and cross-members 18, 20 bridging the side rails.

Right and left front steerable wheels 22, 24 respectively are suspended from frame 12 on the right and left sides for steering the truck vehicle.

A combustion engine 26 is supported on frame 12.

A tandem rear axle 28 is suspended from frame 12 rearward of front steerable wheels 22, 24. Tandem rear axle 28 comprises a first drive axle 30 comprising at least one driven wheel 32 on the right side and at least one driven wheel 34 on the left side and a second drive axle 36 rearward of first drive axle 30. Second drive axle 36 comprises at least one driven wheel 38 on the right side and at least one driven wheel 40 on the left side. All wheels comprise pneumatic tires.

A drivetrain 42 couples combustion engine 26 to first drive axle 30 for driving driven wheels 32, 34. Drivetrain 42 comprises a transmission 44 having an input coupled to an output of combustion engine 26. Drivetrain 42 further comprises a driveshaft 46 coupled to first drive axle 30.

First drive axle 30 comprises a differential gear mechanism housed within a casing 48. Driveshaft 46 is coupled to an input of the differential gear mechanism. Within casing 48 right and left axle shafts extend from the differential gear mechanism to right and left driven wheels 32, 34.

Second drive axle 36 comprises a differential gear mechanism housed within a casing 50. Within casing 50 right and left axle shafts extend from the differential gear mechanism to right and left driven wheels 38, 40.

An electric motor 52 has an output shaft 53 coupled to an input of the differential gear mechanism housed within casing 50. The motor housing may be fastened to casing 50 in any suitable appropriate way or the motor may be mounted remotely and coupled by a suitable coupling to the input of the differential gear mechanism. A battery bank 54 of D.C. batteries is supported from left side rail 16 on a tray 56, and the positive and negative battery bank terminals are coupled by electric cables 58, 60 to a controller 66 which is in turn coupled by electric cables 58A, 60A to input terminals 62, 64 of electric motor 52. Controller 66 controls the direction and magnitude of power flow between electric motor 52 and battery bank 54 while monitoring battery bank voltage and current flow between the two as will be more fully explained later.

Controller 66 also receives electrical data for various parameters associated with operation of combustion engine 26, transmission 44, first drive axle 30, second drive axle 36, and electric motor 52.

At times, controller 66 controls current flow from battery bank 54 to electric motor 52 to cause driven wheels 38, 40 to driven by electric motor 52 through the differential gear mechanism as a function of at least one parameter characterizing operation of combustion engine 26 and/or first drive axle 30. For example, motor 30 may be controlled to cause driven wheels 38, 40 to rotate at the same speed as the respective tandem wheel 32, 34.

Controller 66 can also place drive axle 30 and drive axle 36 in any of selectable operating modes, an example of which is a first mode in which traction force for propelling the truck vehicle is provided only by combustion engine 26 operating drive axle 30, a second mode in which traction force for propelling the truck vehicle is provided only by the electric motor 52 operating drive axle 36, and a third mode in which traction force for propelling the truck vehicle is provided both by combustion engine 26 operating drive axle 30 and by electric motor 52 operating drive axle 36.

At times, controller 66 and electric motor 52 can operate in a regenerative braking mode to recover energy and deliver some of that energy into re-charging battery bank 54. For example, if a driver of the truck vehicle steps on a brake pedal to decelerate the truck vehicle, service brakes associated with driven wheels 32, 34 will be applied while controller 66 causes electric motor 52 to operate as a generator that delivers electricity back to controller 66 which in turn uses that electricity to re-charge battery bank 54. It should be mentioned that electric motor may be either a DC motor or an AC motor, and that the interface between motor 52 and battery bank 54 may comprise electrical equipment such as an inverter or converter for electrical compatibility between motor 52 and battery bank 54.

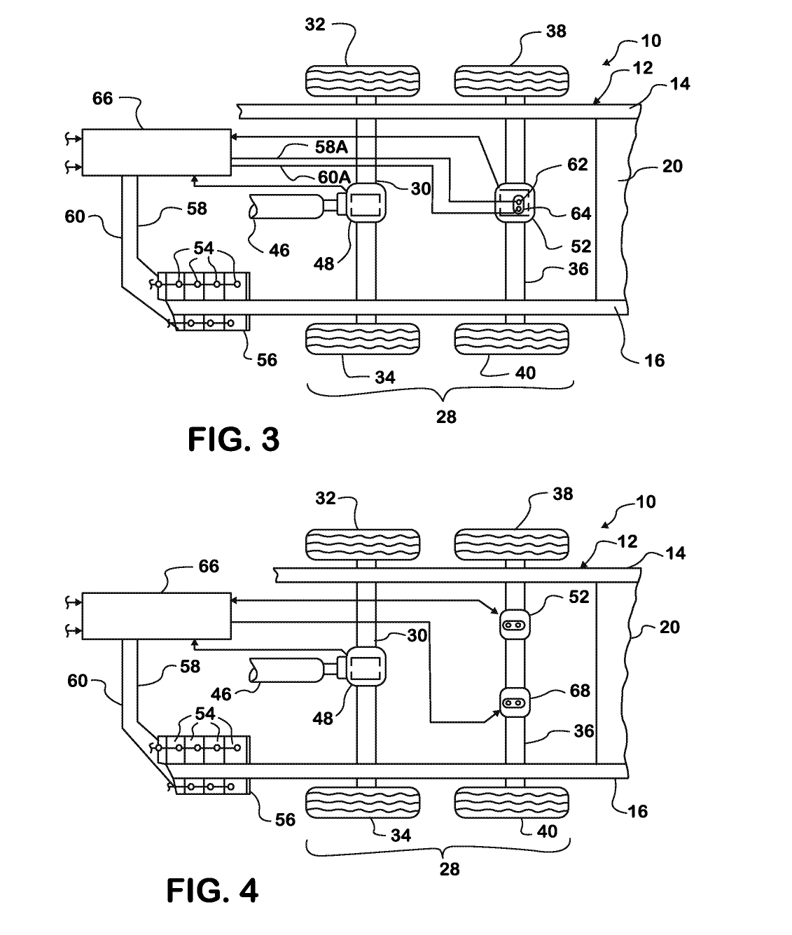

FIG. 3 shows a second embodiment that differs from the one of FIGS. 1 and 2 in that electric motor 52 is integrated with drive axle 36 as an in-line motor for directly driving both driven wheels 38, 40.

FIG. 4 shows a third embodiment that differs from the one of FIG. 3 in that electric motor 52 is integrated with drive axle 36 as an in-line motor for directly driving one of the driven wheels 38, 40 while an additional electric motor 68 is integrated with drive axle 36 as an in-line motor for directly driving the other of the driven wheels 38, 40. Each motor 52, 58 is powered by battery bank 54 and independently controlled by controller 66.

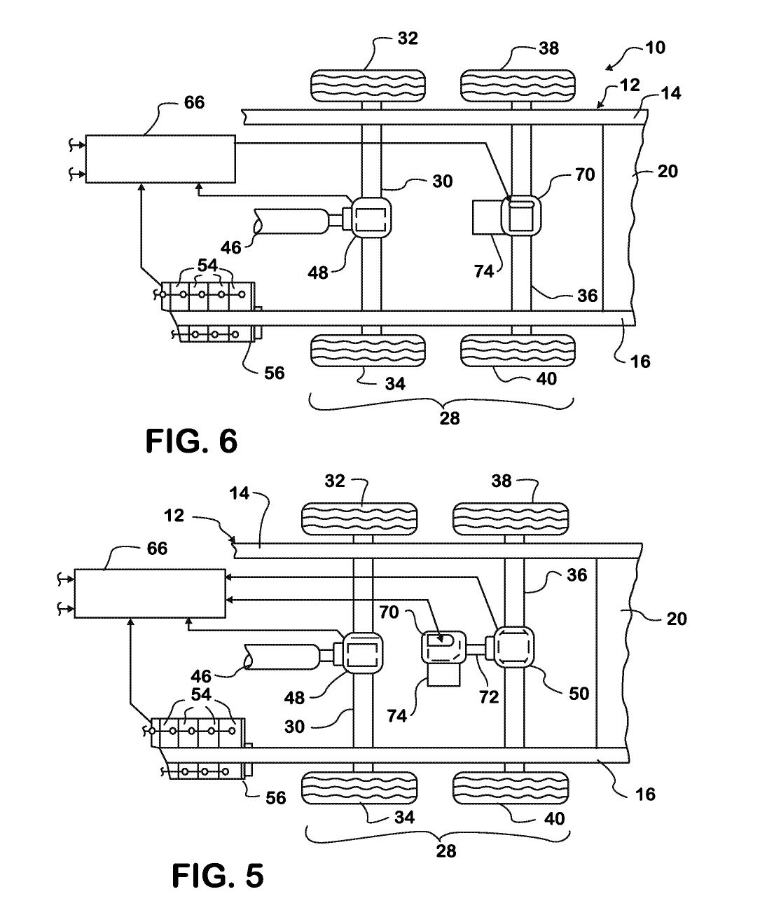

FIG. 5 shows a fourth embodiment that differs from the one of FIGS. 1 and 2 in that electric motor 52 is replaced by a hydraulic motor 70 having an output shaft 72 coupled to an input of the differential gear mechanism housed within casing 50. The truck vehicle comprises a hydraulic energy storage system 74 for operating hydraulic motor 70. Examples of such a power supply are hydraulic pumps and hydraulic accumulators which may be mounted on, or integrated with, the motor itself or mounted in any suitable location and coupled to the motor by hydraulic fluid lines. Controller 66 controls hydraulic motor operation in a manner appropriate to the particular motor, such as by control of stroke or displacement.

Hydraulic motor 70 may also at times be operated as a pump that provides energy recovery during vehicle braking, analogous to the energy recovery from electric motor 52, except that hydraulic fluid is pumped into the hydraulic energy storage system.

FIG. 6 shows a fifth embodiment that differs from the one of FIG. 5 in that hydraulic motor 70 is integrated with drive axle 36 as an in-line motor for directly driving both driven wheels 38,40.

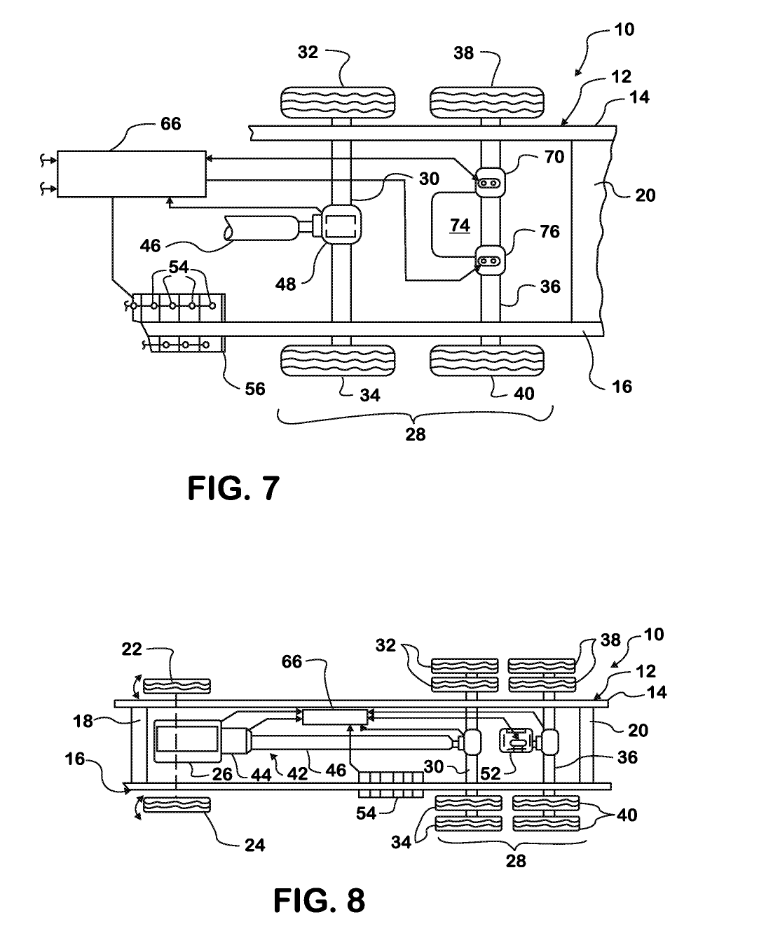

FIG. 7 shows a seventh embodiment that differs from the one of FIG. 6 in that hydraulic motor 70 is integrated with drive axle 36 as an in-line motor for directly driving one of the driven wheels 38, 40 while an additional hydraulic motor 76 is integrated with drive axle 36 as an in-line motor for directly driving the other of the driven wheels 38, 40. Each motor 70, 76 is powered by hydraulic power supply 74 and independently controlled by controller 66.

FIG. 8 shows a truck vehicle chassis 10 that is like the one shown in FIG. 1 except for tandem rear axle 28 having dual right wheels and dual left wheels on each axle 30, 36, a common architecture for Class 8 trucks.

Because the two driven axles of the disclosed tandem axle are driven from different power sources, the disclosed tandem axle may provide improved fuel economy by the elimination of friction that might occur between the axles that are directly coupled due to tire rotational mismatch. Certain existing tandem rear axle truck vehicles can be modified to one of the disclosed tandem axle embodiments without significantly disturbing the configuration of the existing engine, transmission, drive shaft, and first drive axle. The ability to associate an electric motor or a hydraulic motor with a second drive axle can even be accomplished in a short wheel base truck vehicle.

The disclosed hybrid tandem axle provides a redundant traction drive for a truck vehicle because a failure of one prime mover or its drive axle does not necessarily affect the ability of the other prime mover and its drive axle to propel the vehicle. Furthermore, a truck vehicle can operate using the second drive axle alone thereby avoiding the need to use the combustion engine in certain situations.

In each of the disclosed embodiments, the second drive axle 36 can provide not only traction drive for propelling the truck vehicle but when a driver applies service brakes, the second drive axle can be used for regenerative braking. This affords the opportunity for different modes of braking as well as different modes of propulsion.

When a driver applies service brakes of the vehicle in a first mode of tandem rear axle braking, only the service brakes of wheels 32, 34 are applied without any regenerative braking of wheels 38, 40. In a second mode, the service brakes of wheels 32, 34 are applied concurrent with regenerative braking of wheels 38, 40. In a third mode only regenerative braking of wheels 38, 40 occurs.

What is claimed is:

1. A truck vehicle comprising:
a chassis having a length extending front to rear, a right side, and a left side;
front steerable wheels suspended from the chassis on the right side and the left side for steering the truck vehicle;
a combustion engine supported on the chassis;
a tandem rear axle suspended from the chassis rearward of the front steerable wheels and comprising a first drive axle comprising at least one driven wheel on the right side and at least one driven wheel on the left side and a second drive axle rearward of the first drive axle and comprising at least one driven wheel on the right side and at least one driven wheel on the left side;
a drivetrain coupling the combustion engine to the first drive axle for driving the at least one driven wheel on the right side and the at least one driven wheel on the left side of the first drive axle;
and a prime mover other than the combustion engine for driving the at least one driven wheel on the right side and the at least one driven wheel on the left side of the second drive axle.

2. A truck vehicle as set forth in claim 1 in which the prime mover comprises an electric motor powered by a battery bank on-board the truck vehicle.

3. A truck vehicle as set forth in claim 2 in which the second drive axle comprises a differential gear mechanism and the electric motor is coupled to an input of the differential gear mechanism to drive the at least one driven wheel on the right side and the at least one driven wheel on the left side of the first drive axle through the differential gear mechanism.

4. A truck vehicle as set forth in claim 2 in which the electric motor comprises an output that is directly coupled to the at least one driven wheel on one of the sides of the second drive axle.

5. A truck vehicle as set forth in claim 2 in which the electric motor comprises an output that is directly coupled to the at least one driven wheel on one of the sides of the second drive axle and further comprising an additional electric motor powered by the battery bank and having an output directly coupled to the at least one driven wheel on the other of the sides of the second drive axle.

6. A truck vehicle as set forth in claim 1 in which the prime mover comprises a hydraulic motor powered by a hydraulic power supply on-board the truck vehicle.

7. A truck vehicle as set forth in claim 6 in which the second drive axle comprises a differential gear mechanism and the hydraulic motor is coupled to an input of the differential gear mechanism to drive the at least one driven wheel on the right side and the at least one driven wheel on the left side of the first drive axle through the differential gear mechanism.

8. A truck vehicle as set forth in claim 2 in which the hydraulic motor comprises an output that is directly coupled to the at least one driven wheel on one of the sides of the second drive axle.

9. A truck vehicle as set forth in claim 2 in which the hydraulic motor comprises an output that is directly coupled to the at least one driven wheel on one of the sides of the second drive axle and further comprising an additional prime over having an output directly coupled to the at least one driven wheel on the other of the sides of the second drive axle.

10. A truck vehicle as set forth in claim 9 in which the additional prime mover comprises an additional hydraulic motor powered by the hydraulic power supply.

11. A truck vehicle as set forth in claim 1 including a controller for controlling the operation of the prime mover for causing the least one driven wheel on the right side and the at least one driven wheel on the left side of the second drive axle to be driven as a function of at least one parameter characterizing operation of at least one of the combustion engine and the first drive axle.

12. A truck vehicle as set forth in claim 1 including a controller for placing the first drive axle and the second drive axle in any of selectable operating modes that comprise a first mode in which traction force for propelling the truck vehicle is provided only by the first drive axle, a second mode in which traction force for propelling the truck vehicle is provided only by the second drive axle, and a third mode in which traction force for propelling the truck vehicle is provided both by the first drive axle and by the second drive axle.

13. A method of propelling a truck vehicle that comprises a chassis having a length extending front to rear, a right side, and a left side, front steerable wheels suspended from the chassis on the right side and the left side for steering the truck vehicle, a combustion engine supported on the chassis, a tandem rear axle suspended from the chassis rearward of the front steerable wheels and comprising a first drive axle comprising at least one driven wheel on the right side and at least one driven wheel on the left side and a second drive axle rearward of the first drive axle and comprising at least one driven wheel on the right side and at least one driven wheel on the left side, a drivetrain coupling the combustion engine to the first drive axle for driving the at least one driven wheel on the right side and the at least one driven wheel on the left side of the first drive axle, the method comprising:
operating a prime mover other than the combustion engine for driving the at least one driven wheel on the right side and the at least one driven wheel on the left side of the second drive axle.

14. A method as set forth in claim 13 in which the step of operating a prime mover other than the combustion engine comprises operating an electric motor that draws electricity from a battery bank on-board the truck vehicle to drive the at least one driven wheel on the right side and the at least one driven wheel on the left side of the second drive axle.

15. A method as set forth in claim 13 in which the step of operating a prime mover other than the combustion engine comprises operating a hydraulic motor to drive the at least one driven wheel on the right side and the at least one driven wheel on the left side of the second drive axle by delivering hydraulic fluid from a hydraulic power supply on-board the truck vehicle to the hydraulic motor.

16. A method as set forth in claim 13 comprising controlling the operation of the prime mover for causing the least one driven wheel on the right side and the at least one driven wheel on the left side of the second drive axle to be driven as a function of at least one parameter characterizing operation of at least one of the combustion engine and the first drive axle.

17. A truck vehicle as set forth in claim 13 comprising selecting an operating mode for the tandem rear axle from any of selectable operating modes that comprise a first mode in which traction force for propelling the truck vehicle is provided only by the first drive axle, a second mode in which traction force for propelling the truck vehicle is provided only by the second drive axle, and a third mode in which traction force for propelling the truck vehicle is provided both by the first drive axle and by the second drive axle.
